(19) United States
(12) Patent Application Publication
(10) Pub. No.: US 2015/0369425 A1
(43) Pub. Date: Dec. 24, 2015

(54) VAPORIZATION DEVICE FOR LOW-TEMPERATURE LIQUEFIED GAS

(71) Applicant: (KABUSHIKI KAIS HA KOBE SEIKO SHO (KOBE STEEL, LTD.), kobe-shi, Hyogo (JP)

(72) Inventors: Shinji EGASHIRA, Takasago-shi (JP); Yoshihiko TSURU, Takasago-shi (JP); Yuji SUMIDA, Takasago-shi (JP); Kazuhisa FUKUTANI, Kobe-shi (JP); Kosuke HIGASHI, Kobe-shi (JP)

(73) Assignee: (KABUSHIKI KAIS HA KOBE SEIKO SHO (KOBE STEEL, LTD.)), kobe-shi, Hyogo (JP)

(21) Appl. No.: 14/764,291

(22) PCT Filed: Mar. 18, 2014
(86) PCT No.: PCT/JP2014/001547

§ 371 Date: Jul. 29, 2015

(30) Foreign Application Priority Data
Apr. 8, 2013 (JP) 2013-080716

(51) Int. Cl. F17C 9/02

(52) U.S. Cl. CPC F17C 9/02

(57) ABSTRACT

A vaporization device (10) for a low-temperature liquefied gas is provided with: a plurality of heat-transfer pipes (20) into which liquefied natural gas (LNG) is introduced; upper headers (24) which cause natural gas (NG) flowing out from the plurality of heat-transfer pipes (20) to converge; first troughs (28) which supply seawater to the plurality of heat-transfer pipes (20) such that the seawater flows down along outer surfaces of the plurality of heat-transfer pipes (20); and second troughs (36) which drop seawater onto the upper headers (24) from above such that the seawater flows down along outer surfaces of the upper headers (24). In the plurality of heat-transfer pipes (20), the LNG is heated by being subjected to heat exchange with the seawater. In the upper headers (24), vapourized NG which has been heated in the plurality of heat-transfer pipes (20) is heated by being subjected to heat exchange with the seawater flowing down along the outer surfaces of the upper headers (24).

### TECHNICAL FIELD

The present invention relates to a vaporization device for a low-temperature liquefied gas.

### BACKGROUND ART

Conventionally, as disclosed in Patent Documents 1 and 2 mentioned below, a vaporization device for vaporizing a low-temperature liquefied gas such as a liquefied natural gas (LNG) has been known. The vaporization device disclosed in Patent Documents 1 and 2 below includes a heat-transfer pipe panel having a plurality of heat-transfer pipes, and an upper header provided above the heat-transfer pipe panel. Each heat-transfer pipe that composes the heat-transfer pipe panel has a dual pipe structure composed of an inner pipe and an outer pipe. Through the inner pipe, a low-temperature liquefied gas that has been supplied from a LNG header and has passed through a NG header via a vent pipe flows downward. Through the outer pipe, the low-temperature liquefied gas having flown through the inner pipe flows upward. The low-temperature liquefied gas flowing through the outer pipe exchanges heat with external seawater, thereby vaporizing. The low-temperature gas that has vaporized while flowing through each of the inner and outer pipes is collected to the NG header, and is fed from the NG header to a use side. In the vaporization device disclosed in Patent Document 1 below, a NG header is under water in a seawater reservoir unit where seawater is stored, so that the NG header is prevented from being cooled by a low-temperature liquefied gas flowing via a vent pipe through an inner pipe. On the other hand, in the vaporization device disclosed in Patent Document 2 below, a seawater reservoir unit is provided so as to be in contact with an upper half of an upper header, so that the NG header is prevented from being cooled by a low-temperature liquefied gas flowing through an inner pipe. Seawater is supplied to the seawater reservoir unit from above, and the stored seawater is discharged from an intermediate part in the vertical direction.

In Patent Documents 1 and 2, the configuration is such that the NG header is heated by seawater, so that the NG header is prevented from being cooled by a low-temperature liquefied gas flowing via the vent pipe through the inner pipe. In a common LNG vaporization device, however, a low-temperature liquefied gas is supplied from a LNG header that is provided below, which does not cause the cooling of the NG header.

The configuration as disclosed in Patent Documents 1 and 2 has a problem that heating performance is not high. More specifically, the NG header can be heated by seawater stored in the seawater reservoir unit. In the vaporization device disclosed in Patent Document 1, however, seawater that has a lower temperature as having heated the NG header is continuously accumulated in the bottom of the seawater reservoir unit, and hence, the vaporization device does not have high heating performance. The device disclosed in Patent Document 2 is configured to discharge seawater from the seawater reservoir unit. This part for discharge, however, is provided in an intermediate part in the vertical direction in the seawater reservoir unit, and hence, the vaporization device disclosed in Patent Document 2 also has a problem that seawater having a low temperature is pooled in the seawater reservoir unit. Besides, as the seawater reservoir unit is able to heat only the upper half of the NG header, the heating performance exhibited by this configuration is not high, either.

### CITATION LIST

### Patent Document

Patent Document 1: JP8(1996)-157841A
Patent Document 2: JP8(1996)-157842A

### SUMMARY OF THE INVENTION

An object of the present invention is to enhance heating performance when a low-temperature gas is heated by a heat-transfer pipe.

A vaporization device for a low-temperature liquefied gas according to one aspect of the present invention includes: a plurality of heat-transfer pipes into which a liquid-state low-temperature gas is introduced; an upper header in which the low-temperature gas flowing out of the plurality of heat-transfer pipes is collected; a first supply unit configured to supply the heating liquid to the plurality of heat-transfer pipes so that the heating liquid flows down along outer surfaces of the plurality of heat-transfer pipes; and a second supply unit configured to cause the heating liquid to drop over the upper header from above so that the heating liquid flows down along an outer surface of the upper header. In the plurality of heat-transfer pipes, the low-temperature gas is heated by heat exchange with the heating liquid. In the upper header, the low-temperature gas, having been heated in the plurality of heat-transfer pipes, is heated by heat exchange with the heating liquid flowing down along the outer surface of the upper header.

### BRIEF DESCRIPTION OF DRAWINGS

FIG. 1 schematically illustrates principal parts of a vaporization device according to an embodiment of the present invention.

FIG. 2 schematically illustrates principal parts of the vaporization device.

FIG. 3 is a perspective view of a second trough provided in the vaporization device.

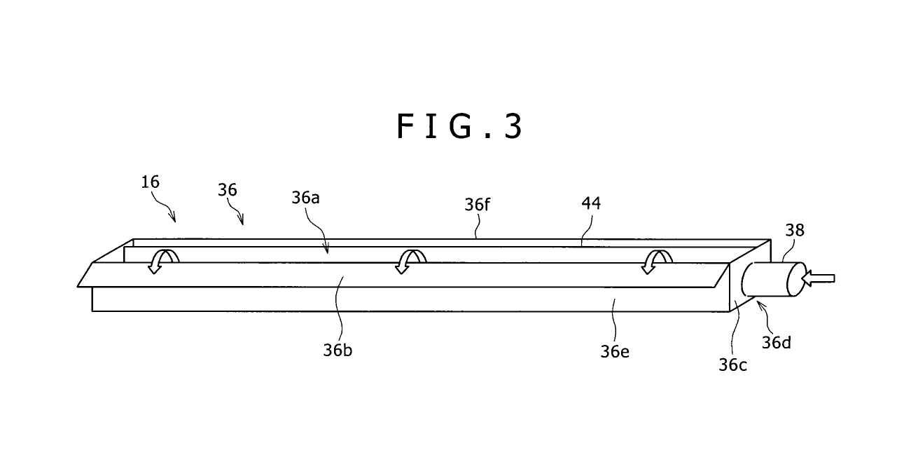

FIG. 4 is a view obtained when the second trough is viewed from above.

FIG. 5 is a diagram for explaining a support structure of a rectifying member in the second trough.

FIG. 6A illustrates a front face of a fixing plate, and FIG. 6B illustrates a front face of a rectifying plate.

FIG. 7 is a diagram for explaining an exemplary state where the height of the rectifying plate is adjusted.

FIG. 8 is a view obtained when a second trough in a vaporization device according to another embodiment of the present invention is viewed from above.

FIGS. 9A to 9C illustrate movable gates.

FIG. 10 is a diagram for explaining a second supply unit in a vaporization device according to another embodiment of the present invention.

### DESCRIPTION OF EMBODIMENTS

Hereinafter, an embodiment for realizing the present invention is described in detail with reference to the drawings.

A vaporization device for a low-temperature liquefied gas according to the present embodiment (hereinafter also simply referred to as a “vaporization device”) is a so-called open rack type vaporizer (ORV). In other words, the vaporization device according to the present embodiment causes heat exchange between a low-temperature liquefied gas supplied thereto and an external heating liquid, thereby vaporizing the low-temperature liquefied gas. The vaporization device according to the present embodiment vaporizes a liquefied natural gas (LNG). Further, in the present embodiment, principally seawater is used as the heating liquid. The vaporization device may be configured as a device that vaporizes or heats a low-temperature liquefied gas other than LNG, for example, a liquefied petroleum gas (LPG), liquid nitrogen (LN2), or the like.

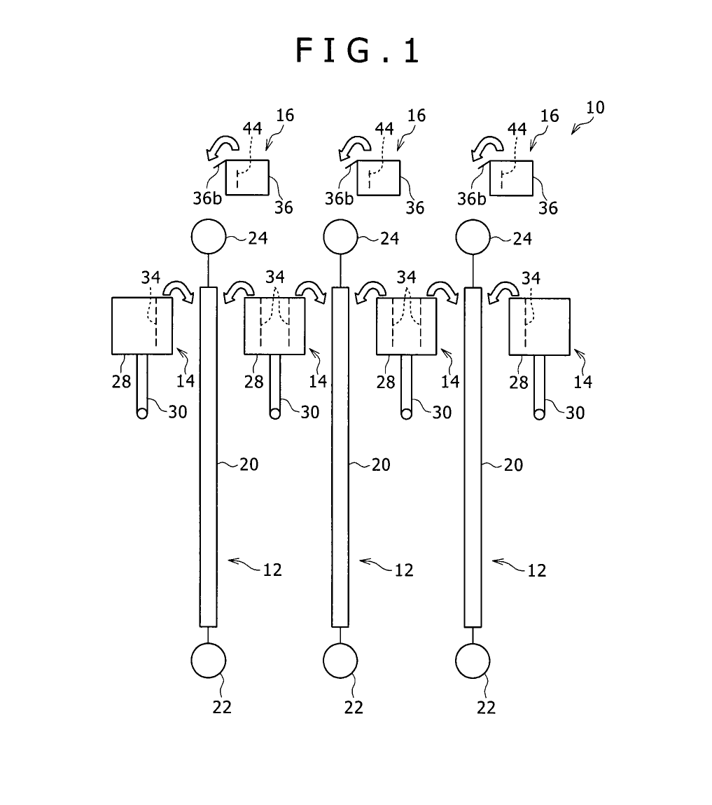

As illustrated in FIG. 1, a vaporization device 10 includes heat-transfer pipe panels 12, first supply units 14, and second supply units 16. Regarding the heat-transfer pipe panels 12, the first supply units 14, and the second supply units 16, the number of each provided therein may be one or a plurality. In FIG. 1, three of the heat-transfer pipe panels 12 and three of the second supply units 16 are illustrated, and four of the first supply units 14 are illustrated. The vaporization device 10 may include more of the heat-transfer pipe panels 12, the first supply units 14, and the second supply units 16 in other cases.

Each heat-transfer pipe panel 12 includes a plurality of heat-transfer pipes 20, a lower header 22 connected to lower end portions of the heat-transfer pipes 20, and an upper header 24 connected to upper end portions of the heat-transfer pipes 20. The number of the heat-transfer pipes 20 composing one heat-transfer pipe panel 12 is, for example, about several tens.

The heat-transfer pipes 20 extend in the vertical direction and are arranged in a state of being parallel with one another, as well as they are arranged on a vertical plane. Each heat-transfer pipe 20 is formed with a metal material having a high thermal conductivity, such as aluminum or an aluminum alloy.

Each lower header 22 is connected to a supply-side manifold, which is not illustrated in the drawings. To each lower header 22, LNG fed from this supply-side manifold is introduced. More specifically, a liquid-state low-temperature gas flows through the lower header 22. As is the case with the heat-transfer pipes 20, the lower headers 22 are formed with a metal material having a high thermal conductivity such as aluminum or an aluminum alloy. LNG flowing through the lower headers 22 is distributed to the plurality of heat-transfer pipes 20 connected to the lower headers 22. LNG therefore flows from below to above through each heat-transfer pipe 20, and on the way, the LNG vaporizes, thereby becoming NG.

Each upper header 24 is configured so that NG flowing out of the heat-transfer pipes 20 is collected therein, and each upper header 24 is connected to an outlet-side manifold, which is not illustrated in the drawings. The upper headers 24 are formed with a metal material having a high thermal conductivity such as aluminum or an aluminum alloy, as is the case with the heat-transfer pipes 20. NG having flown through each upper header 24 joins at the outlet-side manifold, and is fed to a use side.

The first supply unit 14 supplies seawater as heating liquid to each of the heat-transfer pipes 20 that compose the heat-transfer pipe panels 12. The seawater, flowing down along outer surfaces of the heat-transfer pipes 20, exchanges heat with LNG flowing through the heat-transfer pipes 20. The LNG in the heat-transfer pipes 20 vaporizes while exchanging heat with the seawater, thereby becoming NG.

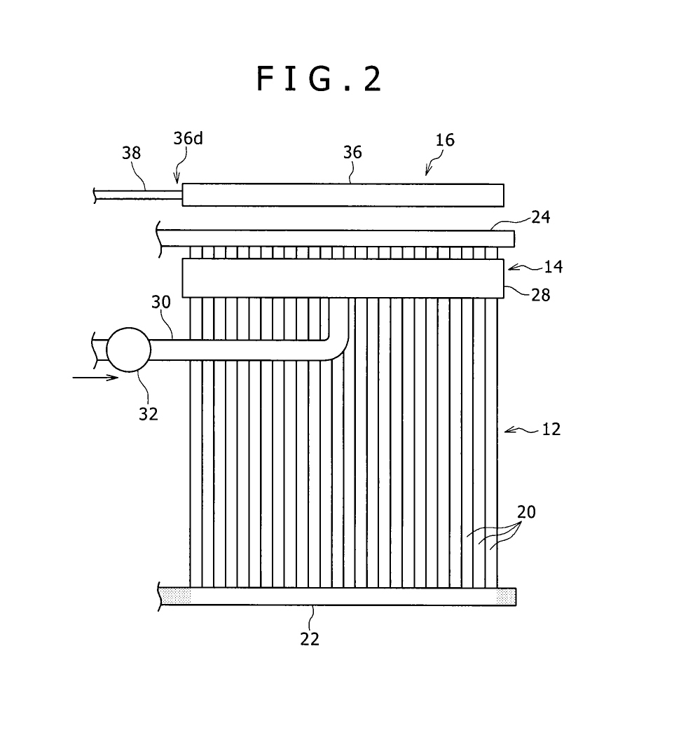

Each first supply unit 14 is arranged between adjacent ones of the heat-transfer pipe panels 12, in the vicinities of upper ends of the heat-transfer pipes 20 that compose the heat-transfer pipe panels 12. As illustrated in FIG. 2, the first supply unit 14 is composed of a first trough 28. The first trough 28 is like a container formed in a box shape that is long in the direction in which the heat-transfer pipes 20 are arrayed, and whose top surface is open. To a bottom surface of the first trough 28, a seawater header 30 that supplies seawater to the inside of the first trough 28 is connected. The seawater header 30 is arranged on the top surface of the first trough 28 in some cases. Seawater flows in the lengthwise direction of the first trough 28, and thereafter, flows over from the top surface to outside the first trough 28. In the example illustrated, the configuration is such that the seawater header 30 is connected thereto at one point in the lengthwise direction, but the configuration is not limited to this. The configuration may be such that the seawater header 30 is connected to the first trough 28 at a plurality of points in the lengthwise direction.

Each seawater header 30 is connected to a seawater manifold 32. Seawater that is pumped up by a pump (not illustrated in the drawings) and distributed from the seawater manifold 32 flows into each seawater header 30.

As illustrated in FIG. 1, rectifying plates 34 are provided in the first troughs 28. Each rectifying plate 34 is in a shape extending in the lengthwise direction of the first troughs 28, and is provided over an entire length thereof in the lengthwise direction. By providing the rectifying plates 34 in the first trough 28, seawater is allowed to equally flow over throughout the entirety of the first trough 28 in the lengthwise direction. Further, by providing the rectifying plates 34 on the both of left and right sides of the seawater header, seawater is allowed to flow over on the both of left and right sides in the same amount.

The second supply units 16 supply seawater as heating liquid to the upper headers 24. The second supply units 16 are provided above the upper headers 24, respectively, so that seawater can be supplied to positions substantially right above the upper headers 24, respectively. The seawater falling down from each second supply unit 16 flows down along outer surfaces of the upper headers 24. The seawater exchanges heat with NG in the upper headers 24 while flowing down along the outer surfaces of the upper headers 24, and further flows down to the heat-transfer pipes 20. The NG exchanges heat with the seawater, thereby being heated.

As illustrated in 3, the second supply unit 16 is composed of a second trough 36. The second trough 36 is like a container formed in a box shape that is long in one direction and whose top surface is open. The second trough 36 is arranged so that the lengthwise direction thereof is parallel with the lengthwise direction of the upper header 24.

The second trough 36 is in a box shape whose cross section is rectangular, and on one of edges on the elongation side of the upper opening 36a of the second trough 36, a guide plate 36b is provided along the edge. The guide plate 36b is inclined, with the end thereof downward. The end of the guide plate 36b is positioned at such a position as to supply seawater to around right above the uppermost portion of the upper header 24. The seawater flowing over from the opening 36a flows down on the guide plate 36b, and thereafter, falls on the upper header 24.

The second trough 36 has a cross section (cross section taken in the direction orthogonal to the lengthwise direction) having an area smaller than that of the cross section of the first trough 28. Further, regarding the amount of seawater supplied to the second trough 36, the flow rate thereof is small, several to several ten percent smaller to that of the seawater supplied to the first trough 28.

A seawater header 38 is connected to a side wall 36c of the second trough 36, which is an end of the second trough 36 in the lengthwise direction. In other words, in the second trough 36, at the end of the second trough 36 in the lengthwise direction, a seawater introduction port 36d is formed. Seawater flows into the seawater header 38, and the seawater flowing through the seawater header 38 flows into the second trough 36 via the introduction port 36d. The seawater supplied to the second trough 36 may be drawn out of the seawater manifold 32.

As the introduction port 36d is formed at the end of the second trough 36 in the lengthwise direction, the second trough 36 is configured so that seawater is introduced from the side thereof. Unlike the configuration in which seawater is introduced from below, therefore, there is no pipe for introducing seawater below the second trough 36. This allows the second trough 36 to be arranged closer to the upper header 24.

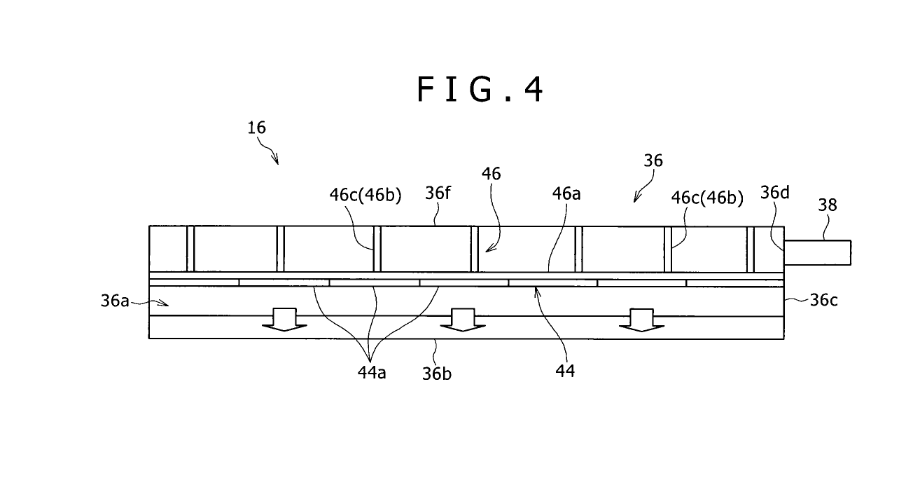

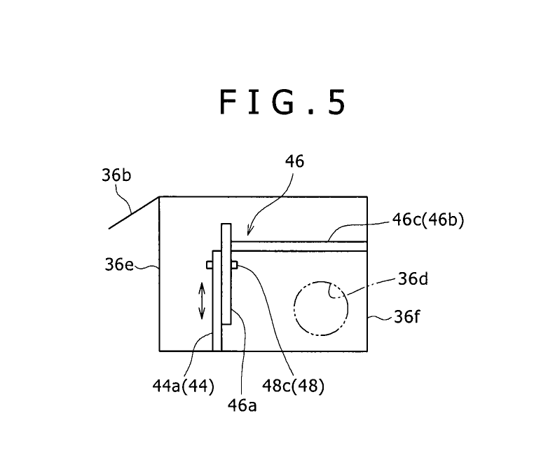

As illustrated in FIGS. 4 and 5, the rectifying member 44 is arranged in the second trough 36. The rectifying member 44 includes a plurality of rectifying plates 44a that are arrayed in the lengthwise direction of the second trough 36. Each rectifying plate 44a is composed of a rectangular flat plate-like member. The rectifying member 44, that is, the plurality of rectifying plates 44a, are arranged so as to be parallel with the side walls (side walls extending in the lengthwise direction) 36e of the second trough 36. Further, as viewed from the introduction port 36d side, the rectifying member 44 is positioned on the guide plate 36b side with respect to the introduction port 36d. The seawater flowing from the introduction port 36d into the second trough 36, therefore, goes straightly along the rectifying member 44, thereby flowing through between the rectifying plates 44a and the side wall (side wall extending in the lengthwise direction) 36f.

In the second trough 36, there are provided a support member 46 for supporting each rectifying plate 44a in the second trough 36, and an adjustment means 48 that is able to individually adjust heights of the rectifying plates 44a.

The support member 46 includes an attachment plate 46a in a shape extending in the second trough 36 in the lengthwise direction thereof, and a fixing part 46b for fixing the attachment plate 46a to the second trough 36.

The attachment plate 46a is formed in a plate-like form, and is in a perpendicular posture so as to be parallel to the side wall 36e on the elongation side (side walls extending in the lengthwise direction) of the second trough 36. A gap is formed between the lower end of the attachment plate 46a and the bottom surface of the second trough 36, so that seawater can pass therethrough.

The fixing part 46b includes a plurality of fixing rods 46c that are arranged at distances in a direction along the side wall 36e on the elongation side (side wall extending in the lengthwise direction) of the second trough 36. One end of each fixing rod 46c is fixed to a side wall 36f, which is opposed to the side wall 36e to which the guide plate 36b is mounted. The other end of the fixing rod 46c is fixed to the attachment plate 46a.

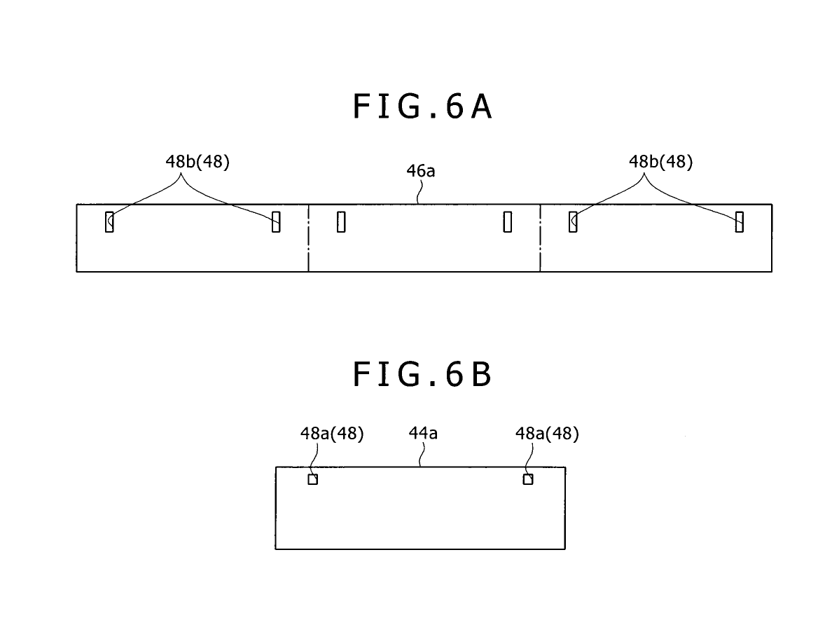

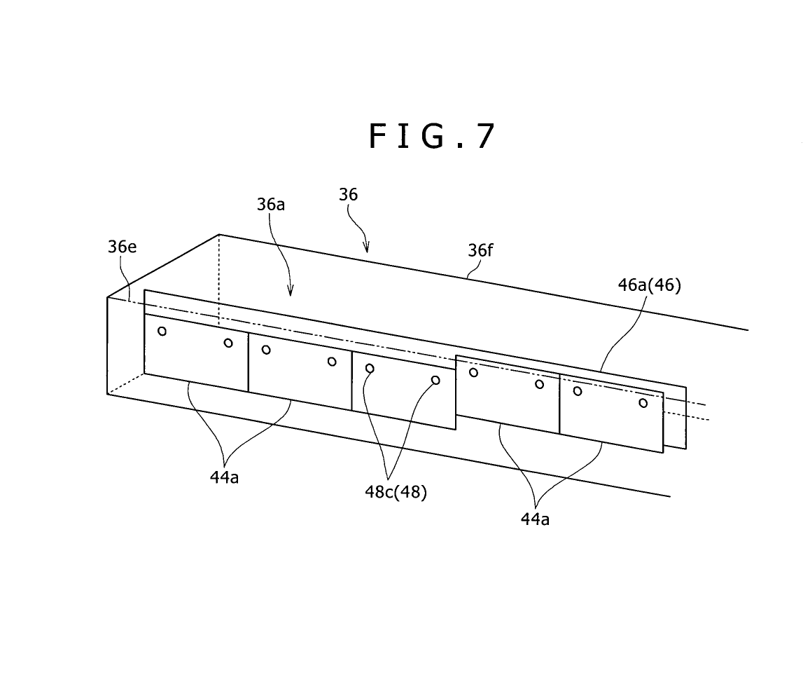

As illustrated in FIGS. 6A and 6B, the adjustment means 48 includes insertion holes 48a that are formed in each rectifying plate 44a, oblong holes 48b formed in the attachment plate 46a, the number of which corresponds to the number of the insertion holes 48a, and fastening tools 48c (see FIG. 5) inserted through the oblong holes 48b and the insertion holes 48a. The oblong hole 48b is in a shape elongated in the vertical direction. The oblong hole 48b is provided at a position where each rectifying plate 44a is arranged. By changing the position at which the fastening tool 48c passes in each oblong hole 48b, the height position of the corresponding rectifying plate 44a is changed accordingly. It is possible, therefore, for example, to set the height of the rectifying plate 44a positioned on the downstream side to a low level, and at the same time, to set the height of the rectifying plate 44a positioned on the upstream side (on the introduction port 36d side) to a higher level, as illustrated in FIG. 7. A change of the height position of the rectifying plate 44a causes a change of the gap width between the lower end part of the rectifying plate 44a and the bottom surface of the second trough 36. This makes it possible to address the problem that influences of the flow rate, the flow velocity, the pressure loss and the like of seawater in the second trough 36 cause the water pressure on the upstream side and that on the downstream side to be different. It is possible, therefore, to set so that a substantially same amount of seawater flows over at arbitrary places in the lengthwise direction of the second trough 36. Each rectifying plate 44a can be detached at maintenance and other occasions. Thus maintainability can be improved.

In the example illustrated in FIGS. 6A and 6B, the attachment plate 46a is provided with the oblong holes 48b, at a rate of two oblong holes 48b per each rectifying plate 44a. Further, two insertion holes 48a are formed in each rectifying plate 44a. The configuration, however, is not limited to this; the configuration may be such that one, three, or more insertion holes 48a are formed in each rectifying plate 44a. In this case, the oblong holes 48b may be formed so that the number of the same corresponds to the insertion holes 48a.

Further, in the example illustrated in FIGS. 6A and 6B, the configuration is such that the oblong holes 48b are formed in the attachment plate 46a, but the configuration is not limited to this. The configuration may be such that the insertion holes 48a are formed in the attachment plate 46a, and the oblong holes 48b are formed in the rectifying plates 44a.

As described above, in the present embodiment, NG heated by seawater and vaporized in each heat-transfer pipe 20 is collected to the upper header 24. In the upper header 24, NG is heated by seawater that falls from above the upper header 24 and flows down along the outer surface of the upper header 24. In other words, seawater supplied from the second supply unit 16 falls from above the upper header 24 toward the upper header 24, flows down along the outer surface of the upper header 24, and thereafter flows down to the heat-transfer pipes 20. Therefore, by heating the upper header 24, such a situation that the seawater having a low temperature is retained in the upper header 24 can be avoided. Further, portions that contribute to heating in the upper header 24 can be increased. As a result, NG heating performance can be improved.

Further, in the present embodiment, seawater that is introduced from the introduction port 36d, which is positioned at an end of the second trough 36 in the lengthwise direction, into the inside of the second trough 36 flows through the inside of the second trough 36, in the lengthwise direction of the second trough 36. In the configuration in which seawater is introduced from below the second trough, the second trough has a large size in the vertical direction so as to rectify the introduced seawater in some cases. In contrast, such a problem does not occur in the configuration in which seawater is introduced from the end of the second trough 36 as is the case with the present embodiment. The second trough 36, therefore, may have a smaller size in the vertical direction.

Further, in the present embodiment, the rectifying member 44 is arranged in the second trough 36. The seawater introduced into the second trough 36, therefore, flows through the second trough 36, while being rectified by the rectifying member 44. The seawater in the second trough 36 flows over from the top (opening 36a) of the second trough 36, and falls on the upper header 24 from above. This makes it possible to suppress a problem that seawater introduced into the inside of the second trough 36 immediately flows over in the vicinity of the introduction port 36d.

Further, in the present embodiment, a plurality of rectifying plates 44a are arrayed in the lengthwise direction of the second trough 36, and each rectifying plate 44a is configured so that the height thereof can be adjusted individually. Therefore, according to the flow rate and the flow velocity of the seawater introduced into the inside of the second trough 36, the height of each rectifying plate 44a can be adjusted appropriately. This makes it possible to make the amount of seawater flowing over from the second trough 36 uniform over the entirety of the second trough 36 in the lengthwise direction.

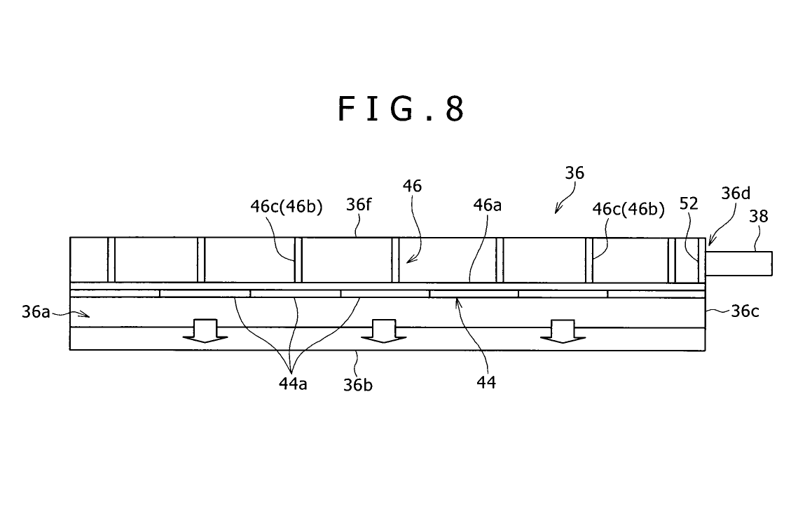

It should be noted that the present invention is not limited to the above-described embodiment, but can be varied, improved, and the like in many ways without departing from the scope of the present invention. For example, as illustrated in FIG. 8, a movable gate 52 may be provided at the introduction port 36d of the second trough 36. The movable gate 52 is arranged between the side wall 36f and the attachment plate 46a. The movable gate 52 is provided in every second trough 36. Each movable gate 52 is provided displaceably so as to vary the opening area of the introduction port 36d. By moving each movable gate 52, for example, in the vertical direction, the inflow of seawater into each second trough 36 can be adjusted. This makes it possible to prevent the respective amounts of seawater falling over a plurality of the upper headers 24 from varying among the same.

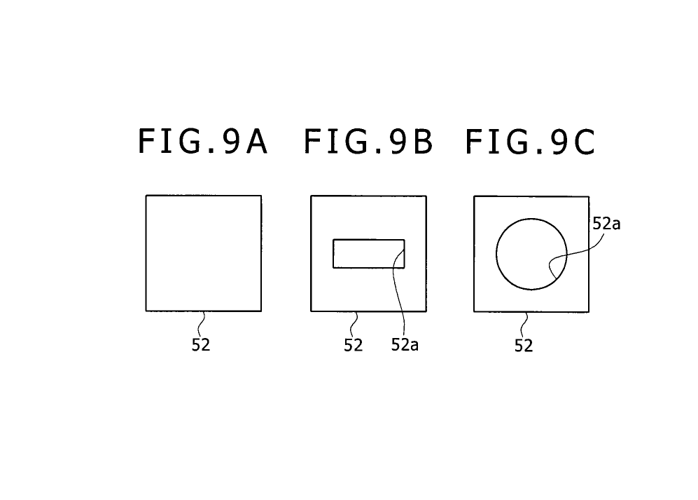

The movable gate 52 may be formed in a flat plate-like form without any aperture as illustrated in FIG. 9A, or alternatively, may be formed in a flat plate-like form with an aperture 52a, as illustrated in FIGS. 9B and 9C. The movable gate 52 having the aperture 52a can be formed with, for example, a punching metal. In the case where the aperture 52a is formed in the movable gate 52, when much seawater is supplied, a part of seawater passes through the aperture 52a of the movable gate 52. This suppresses disturbance of the liquid surface of seawater after passing through the movable gate 52.

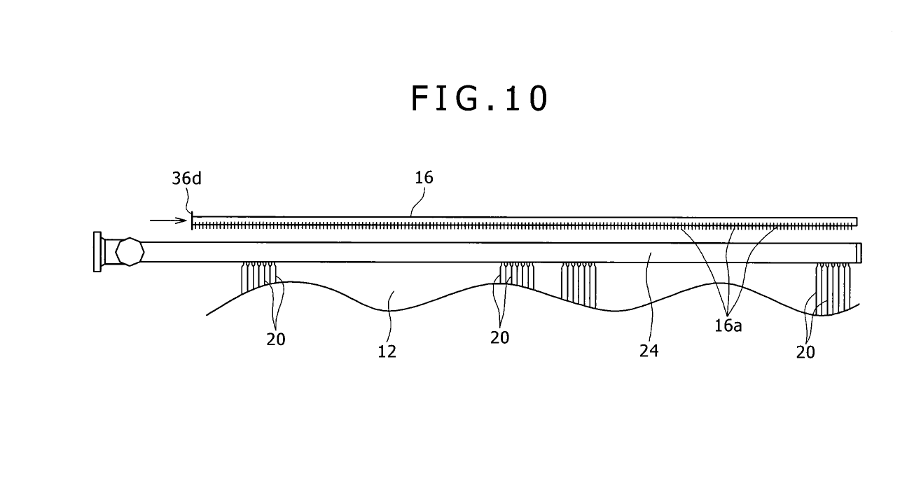

In the above-described embodiment, the second supply unit 16 is formed with the container-like second trough 36, but the configuration is not limited to this. For example, as illustrated in FIG. 10, the configuration may be such that the second supply unit 16 is in a straight-pipe shape extending straightly, and a multiplicity of apertures 16a are formed in the pipe walls. The apertures 16a are arrayed in the axis direction of the second supply unit 16, and are formed in, for example, a lower part of the second supply unit 16. The second supply unit 16 like this can be formed with, for example, a sparge pipe. In this case, seawater flows through the introduction port 36d at the end of the second supply unit 16 formed in a pipe-like shape, thereby flowing into the inside of the second supply unit 16. The seawater, while flowing through the second supply unit 16 in the lengthwise direction thereof, flows down through the apertures 16a formed in the pipe walls. In this aspect, the configuration of the second supply unit 16 can be simplified.

The following description gives an outline of the above-described embodiment.

(1) In the above-described embodiment, a low-temperature gas heated in each of heat-transfer pipes by heating liquid is collected to the upper header. In each upper header, the low-temperature gas is further heated by heating liquid that falls from above the upper header and flows down along an outer surface of the upper header. In other words, the heating liquid supplied from the second supply unit falls from above the upper header toward the upper header and thereafter flows down along the outer surface of the upper header. On the outer surface of the upper header, therefore, the heating liquid flows from an upper part thereof to a lower part thereof, and thereafter, flows along outer surfaces of the heat-transfer pipes above the first supply unit, thereby joining with the heating liquid from the first supply unit. This makes it possible to avoid such a situation in which heating liquid that comes to have a low temperature when heating the upper header is continuously in contact with the upper header. This improves performance of heating of the low-temperature gas. At the same time, the entirety of the surface of the upper header, as well as the surfaces of the upper parts of the heat-transfer pipes, which conventionally did not contribute to heating, can be caused to contribute to heating effectively. More specifically, in the heat-transfer pipes, heat exchange occurs between the heating liquid, falling from above the upper header and flowing down from the upper header, and the low-temperature gas. Therefore, in the upper end parts of the heat-transfer pipes also, which did not contribute to heating conventionally, heating of the low-temperature gas can be performed. This improves performance of the vaporization device for heating of the low-temperature gas.

(2) The second supply unit may have a shape elongated in the lengthwise direction of the upper header. The second supply unit may have an introduction port formed at the lengthwise-direction end of the second supply unit through which the heating liquid is introduced. In this case, the heating liquid in the second supply unit may have a flow rate of 1/10 or less as compared with that of the heating liquid in the first supply unit, and the dimension in the vertical direction and the dimension in the width direction of the second supply unit can be decreased.

(3) The second supply unit may be formed in a container form whose top is open and that has the introduction port at the end in the lengthwise direction. In the second supply unit, a rectifying member may be provided. The second supply unit may be configured so that the heating liquid introduced to the inside of the second supply unit flows through the second supply unit while being rectified by the rectifying member, and flows over from the top of the second supply unit.

In this aspect, the heating liquid introduced to the second supply unit flows through the second supply unit, while being rectified by the rectifying member. The heating liquid in the second supply unit flows over from the top (opening) of the second supply unit, falls down to the upper header from above. This, therefore, prevents the heating liquid introduced into the inside of the second supply unit from immediately flowing over in the vicinity of the introduction port.

(4) The rectifying member may include a plurality of rectifying plates that are arrayed in the lengthwise direction of the second supply unit. An adjustment means that can adjust the height of each rectifying plate individually may be provided.

In this aspect, a plurality of rectifying plates are arrayed in the lengthwise direction of the second supply unit, and each rectifying plate is configured so that the height thereof can be adjusted individually. Therefore, the height of each rectifying plate can be adjusted appropriately depending on the flow rate and the flow velocity of the heating liquid introduced into the inside of the second supply unit. This makes it possible to make the amount of the heating liquid flowing over from the second supply unit uniform over the second supply unit in the lengthwise direction.

(5) The plurality of heat-transfer pipes, the upper header, the first supply unit, and the second supply unit may be each plural in number. At the introduction port of each of the plurality of second supply units, a movable gate that can adjust an amount of inflow of a heating medium may be provided.

In this aspect, by adjusting the movable gate, the inflow of the heating medium into each second supply unit can be adjusted. This makes it possible to prevent the respective amounts of the heating liquid falling over a plurality of the upper headers from varying among the same.

(6) The second supply unit may be formed in a straightly extending pipe form, with a multiplicity of apertures formed in a pipe wall thereof.

In this aspect, the heating liquid flows into the inside of the second supply unit through the introduction port formed at an end of the second supply unit formed in a pipe form. The heating liquid flows down through the apertures formed in the pipe wall, while flowing through the inside of the second supply unit in the lengthwise direction. In this aspect, the configuration of the second supply unit can be simplified.

As described above, according to the above-described embodiment, the performance of heating of the low-temperature gas, heated by the heat-transfer pipes, can be improved.

1. A vaporization device for a low-temperature liquefied gas, the device comprising:
a plurality of heat-transfer pipes into which a liquid-state low-temperature gas is introduced;
an upper header in which the low-temperature gas flowing out of the plurality of heat-transfer pipes is collected;
a first supply unit configured to supply the heating liquid to the plurality of heat-transfer pipes so that the heating liquid flows down along outer surfaces of the plurality of heat-transfer pipes; and
a second supply unit configured to cause the heating liquid to drop over the upper header from above so that the heating liquid flows down along an outer surface of the upper header,
wherein, in the plurality of heat-transfer pipes, the low-temperature gas is heated by heat exchange with the heating liquid, and
in the upper header, the low-temperature gas, having been heated in the plurality of heat-transfer pipes, is heated by heat exchange with the heating liquid flowing down along the outer surface of the upper header.

2. The vaporization device for a low-temperature liquefied gas according to claim 1,
wherein the second supply unit has a shape elongated in the lengthwise direction of the upper header, and
in the second supply unit, an introduction port through which the heating liquid is introduced is formed at an and in a lengthwise direction of the second supply unit.

3. The vaporization device for a low-temperature liquefied gas according to claim 2,
wherein the second supply unit is formed in a container form whose top is open and that has the introduction port at the end in the lengthwise direction,
a rectifying member is provided in the second supply unit, and
the second supply unit is configured so that the heating liquid introduced to the inside of the second supply unit flows through the second supply unit while being rectified by the rectifying member, and flows over from the top of the second supply unit.

4. The vaporization device for a low-temperature liquefied gas according to claim 3,
wherein the rectifying member includes a plurality of rectifying plates that are arrayed in the lengthwise direction of the second supply unit, and
an adjustment means that can adjust a height of each rectifying plate individually is provided.

5. The vaporization device for a low-temperature liquefied gas according to claim 2,
wherein the plurality of heat-transfer pipes, the upper header, the first supply unit, and the second supply unit are each plural in number, and
at the introduction port of each of the plurality of second supply units, a movable gate that can adjust an amount of inflow of a heating medium is provided.

6. The vaporization device for a low-temperature liquefied gas according to claim 2,
wherein the second supply unit is formed in a straightly extending pipe form, with a multiplicity of apertures formed in a pipe wall thereof.
